(19) United States
(12) Patent Application Publication
(10) Pub. No.: US 2003/0207239 A1
(43) Pub. Date: Nov. 6, 2003

(54) Visual rhythm apparatus and method of using the same

(76) Inventor: James K. Langlois, Mechanicsville, VA (US)

Correspondence Address: Tony D. Alexander, TECHNOLOGY LEGAL COUNSEL LLC, POST OFFICE BOX 1728, EVANS, GA, 30809, US

(21) Appl. No.: 10/139,702

(22) Filed: May 3, 2002

(51) Int. Cl. G09B 17/00

(52) U.S. Cl. 434/178

(57) ABSTRACT

The present invention provides a visual rhythm instructional apparatus and method that helps the music instructor convey note reading and rhythm ability to students in a natural manner. The present invention is suitably configured in a hardware and software version. The present invention provides an apparatus and method that facilitates proper counting in any time signature. To this end, the apparatus in accordance with the present invention has indicia to ensure proper beat, count and measure delineation so that proper time signature is established. The rhythm is built with the notes/rests by placing them one by one in the appropriate location on the apparatus, giving the user the ability to count and play the rhythm.

### COPYRIGHT NOTICE

A portion of the disclosure of this patent document contains material that is subject to copyright protection. The copyright owner has no objection to the facsimile reproduction by anyone of the patent disclosures, as it appears in the Patent and Trademark Office patent files or records, but otherwise reserves all copyright rights whatsoever.

### FIELD OF THE INVENTION

The present invention relates generally to educational tools and method for teaching students to read notes and rhythm in particular.

### BACKGROUND OF THE INVENTION

For many people, learning to read music is a very intimidating thought. In particular, the thought of reading notes and rhythm pose one of the most formidable mental challenges to overcome. Though the learning process is not as difficult as it may initially seem, there is a grain of truth to the level of difficulty. When faced with sheet music for the first time, many students see a series of foreign characters and put up mental barriers to learning. In order to address this problem, attempts have been made to appeal to the student's other sensory learning capabilities, namely, teaching students auditorily.

An example of such a method is the five-step method, which comprises, a method of teaching music that first teaches students to understand musical notes in auditory relation to each other. Once students learn to auditorily distinguish notes, they are then taught to read music visually. It is assumed that the student's auditory understanding of music helps them to master visual reading and playing of music. This method of teaching music from rote to note is believed to help the development of musical skills more quickly and more thoroughly by means of using auditory, visual and vocal elements to understand and play music.

At the outset of such a process, music students are taught to sing songs all comprised of the same three predetermined musical notes such as “Mary Had a Little Lamb” and “Hot Cross Buns.” Students sing words, and also the sounds “doo” and “too,” to the melody of the song as a method of strengthening the tongue. While singing the three-note-songs, students then add corresponding hand signals to each note.

In the second step, students continue to sing three-note-songs with corresponding hand signals and “doo” and “too” sounds according to Step 1. Students are then taught to play a three-note-song on a recorder by ear (without the use of sheet music). After the students have mastered a three-note-song on the recorder, the notes to the song are drawn on an apparatus or on a handout sheet, for example, having a specialized staff consisting of only two lines. The teacher points to the notes as they correspond to the notes played. At this point, the students can begin to understand how the music they are playing and singing can be visually read and understood. The teacher can now begin to visually teach musical concepts to the students by means of the two line staff.

In the third step, students are introduced to the traditional five line musical staff. They continue to play and sing three-note-songs by reading the notes from this staff and also learn other songs containing predetermined sets of three different notes. Students are taught words to the songs as well as the corresponding syllables (i.e., so la te and mi re do). Students continue to sing with “doo” and “too” as a vocal exercise.

In the fourth step, students continue to play three-note-songs. They are also taught songs containing other three note sets. At this point, rhythm instruments are added while students play or sing to keep them playing or singing together at the same tempo. Students continue to sing the words of the song, the corresponding syllables (i.e., so la te, mi re do, and la so fa), and “doo” and “too” vocal exercises.

In the fifth step, students learn new songs that mix all of the notes. Once songs are learned, rhythmic instruments can be added. Students continue to learn songs and their words and corresponding note syllables (i.e. do re mi fa so la te do). Students also continue “doo” and “too” voice exercises.

Unfortunately, problems generally stem from the fact that a musical note does not always visually represent its time value by the physical space it takes up in a measure. Therefore, the transition from the auditory to the visual remains difficult for the student. It is especially difficult in percussion rhythm because a whole note and a quarter note sound exactly the same because the decay of a percussion instrument is identical on both.

An additional attempt has been made to facilitate the comprehension of rhythm notation. In particular, the method emphasizes the association of written rhythms and their corresponding sounds. Unlike other music teaching methods, which typically try to teach the many aspects of musicianship, this method focuses on one specific skill, that of sight-reading rhythm notation. The learning process consists of a visual music display accompanied by music. The student is then required to play along by pressing the space bar on their keyboard in time with the music. As an exercise progresses, the software shows the relationship between the written notes and the rhythms they represent. A cursor moves from note to note while the computer plays them with a reference tone. When the space bar is depressed, a tone of a different pitch is sounded. The object is to make the reference tone and the space bar tone sound in perfect synchrony.

Again, the difficulty for the student remains because these series of exercises do not give the student an adequate appreciation for the time a note should be held for. As a result, students will misread a note because it is not readily apparent to them from the physical space between it and the next note, the duration of time the note should be held.

Moreover, counting rhythm can also be a challenge to students without an adequate visual representation. Additionally, counting difficulties can result when the time signature changes from, for example a quarter signature to an eighth signature or from common time to cut time.

Therefore, there is an existing need for a visual rhythm apparatus and method that helps the music instructor convey note reading and rhythm to students in a natural manner. In particular, there is a need for an apparatus and method that addresses the most common difficulty associated with learning to read notes and rhythm, namely, visualizing time values in a measure. Additionally, there is an existing need for an apparatus and method that facilitates proper counting in any time signature.

### SUMMARY OF EXEMPLARY EMBODIMENTS

The present inventor has discovered a unique way of addressing all of the above limitations and providing additional advantages. In an exemplary embodiment in accordance with the present invention, a visual display apparatus and method is provided which assigns a correct relative physical length to notes and the count for different time signatures.

In a preferred embodiment, it is an objective of the invention to provide an apparatus suitably configured to provide a convenient means of teaching students to read notes and rhythm. In particular, the visual rhythm apparatus in accordance with the present invention represent the occurrence of rhythm during time, in both a physical and visual representation.

Yet another objective of the present invention is to provide a teaching aid for both private and classroom rhythm education. The apparatus in accordance with the present invention can be used for any instrument, which uses traditional musical notation.

Another objective of a preferred embodiment of the present invention is to provide a method of using the apparatus to assist in the instruction of a music student. In particular, there is a need for an apparatus and method that addresses the most common difficulty associated with learning to read notes and rhythm, namely, visualizing time values in a measure.

Still another objective of the present invention is to provide a means of assisting students to make the transition from playing “by ear” to reading music notation. In the furtherance of this and other objectives, the visual rhythm apparatus in accordance with the present invention helps the student build each measure, one by one. This will insure that the student understands note values, the proper count and prevent reliance on playing “by ear.”

A principal objective of the present invention is to provide an apparatus and method that facilitates proper counting in any time signature. To this end, the apparatus in accordance with the present invention has indicia to ensure that the proper beat, counting bar and measure delineator are installed in the appropriate place on the apparatus and that the proper time signature is established. The rhythm is built with the notes/rests by placing them one by one in the appropriate location on the apparatus, giving the user the ability to count and play the rhythm.

As an aid to the blind, another objective is to provide a version of the visual rhythm apparatus with raised notes/rests, counting bars, and time signatures. Each piece is readily recognizable through touch. Each note/rest is also immediately recognizable by its length. Each measure will be built by placing the notes/rests in place and then the rhythm can be played. For the blind, musical notation and rhythm becomes visual through touch. The visual rhythm apparatus becomes virtual “sight” for the blind.

Still another objective of the present invention is to provide an alternative to the current systems by providing the apparatus and method in computer readable form so the user can learn the same techniques on a personal computing device.

As a further objective, international versions of the visual rhythm apparatus are provided in all languages. The only translation necessary would be for the instructions, and for the words and numbers on the apparatus. Also, international versions for the blind are provided with raised notes/rests, time signatures, and counting bars, to assist the blind worldwide in learning and reading and writing rhythm notation.

Further objectives, features and advantages of the invention will be apparent from the following detailed description taken in conjunction with the accompanying drawings.

### BRIEF DESCRIPTION OF THE DRAWINGS

FIG. 1 is an illustration of a side-perspective view of a visual rhythm apparatus embodying the present invention, shown in a standard pre-use orientation.

FIG. 2 shows a front schematic view an exemplary embodiment of the workstation portion of a visual display apparatus in accordance with the present invention, as shown in FIG. 1.

FIG. 3 shows a front schematic view an exemplary embodiment of the building template for proper beat, counting bar and measure delineator installation.

FIG. 4 shows an aerial illustration an exemplary storage device for keeping the pieces of the non-computerized version of the visual rhythm apparatus in accordance with the present invention.

FIG. 5 shows an illustration of quarter time beat and counting bars in accordance with an exemplary embodiment of the present invention.

FIG. 6 shows an illustration of eighth time beat and counting bars in accordance with an exemplary embodiment of the present invention.

FIG. 7 shows an illustration of cut time beat, counting bars and time signature numbers in accordance with an exemplary embodiment of the present invention.

FIG. 8 shows an illustration of exemplary relative physical lengths for standard notes.

FIG. 9 shows an illustration of exemplary relative physical lengths for triplet/shuffle notes.

FIG. 10 shows an illustration of exemplary relative physical lengths for dotted notes.

FIG. 11 shows an illustration of exemplary relative physical lengths for double dotted notes.

FIG. 12 shows an illustration of exemplary relative physical lengths for tied notes.

FIG. 13 shows a schematic representation of the parts list in accordance with an exemplary embodiment of the present invention.

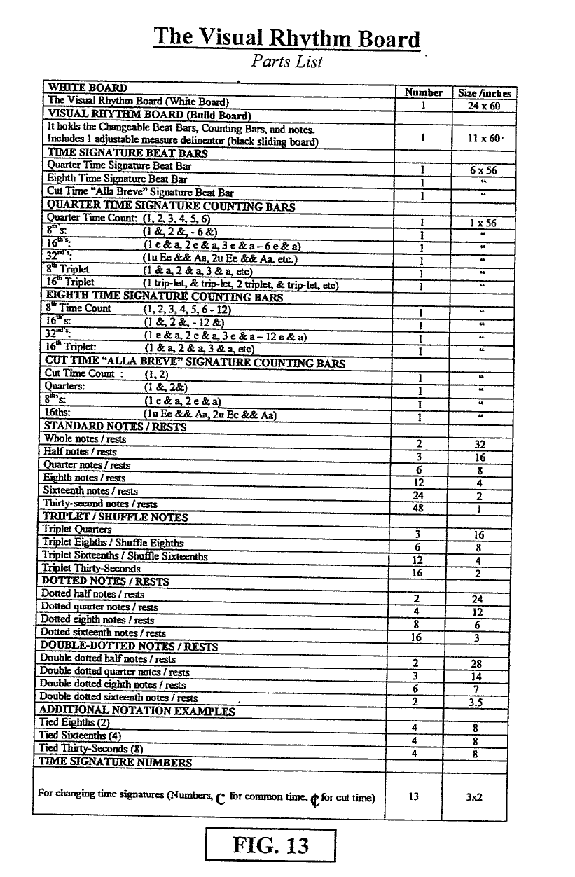

### DETAILED DESCRIPTION OF THE PREFERRED EMBODIMENTS

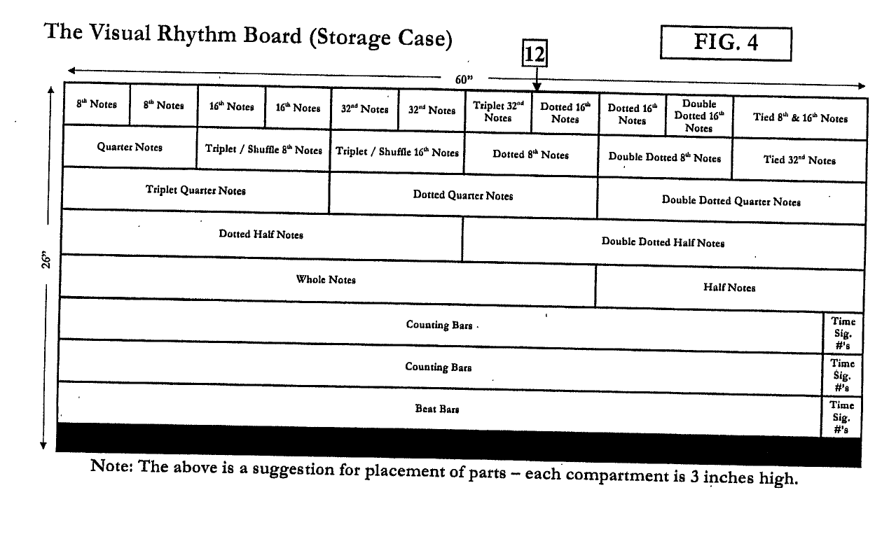

The present invention provides a visual rhythm apparatus and method that helps the music instructor convey note reading and rhythm ability to students in a natural manner. The present invention is suitably configured in a hardware and software version. The hardware versions, in this instance, referring to an apparatus that must be manipulated manually and not to be confused with the hardware components that manipulates the computer readable form of the present invention. The hardware version of the present invention consists of several parts that are enumerated in the following table, and would be acceptably stored in a device similar to that illustrated in FIG. 4. Please note that number and size of parts may vary as long as an appropriate size ratio exists between the pieces.

The difficulty in teaching students to read notes and rhythm is that a musical note does not always visually represent its time value by the physical space it takes up in a measure. It's especially difficult in percussion rhythm because a whole note and a quarter note sound exactly the same because the decay of a percussion instrument is identical on both notes.

Many times a student misreads a note because the physical space between it and the next note does not clearly represent the time it should last for. Counting rhythm can also be a challenge to students. The concept of counting quarters, eighths, sixteenths, and thirty-seconds is difficult to understand without a visual representation. Another difficulty in counting is when the time signature changes from a quarter signature to an eight signature, or from common time to cut time. The visual rhythm apparatus overcomes this problem by making the notes and the count for different time signatures a correct relative physical length horizontally (e.g., A whole note is 32 inches, A half note is 16 inches, A quarter note is 8 inches, An 8^{th} note is 4 inches, A 16^{th} note is 2 inches and A 32^{nd} note is 1 inch, respectively).

On the back of each note is its rest. Rests are obviously the same lengths as their note value. Dotted notes are represented with the same measurement. A dotted half note is 24 inches—equal to a half note plus a quarter. A dotted quarter note is 12 inches—equal to a quarter note plus an 8^{th}. A dotted 8^{th} note is 6 inches—equal to an 8^{th} note plus a 16^{th}. A dotted 16^{th} note is 3 inches—equal to a 16^{th} note plus a 32^{nd}. A double-dotted half note is 28 inches—equal to a half note, plus a quarter and an 8^{th}. A double-dotted quarter note is 14 inches—equal to a quarter note, plus an 8^{th} and a 16^{th}. A double-dotted 8^{th} note is 7 inches—equal to an 8^{th} note, plus a 16^{th} and a 32^{nd}. A double-dotted 16^{th} note is 3.5 inches—equal to a 16^{th}, plus a 32^{nd} and a 64^{th}.

Triplets are represented with the same measurement. One side represents the three notes as quarters, 8^{th}'s, or 16^{th}'s, and the other side shows the middle triplet as a rest creating the shuffle.

The apparatus can represent the time signatures 1/4 through 6/4, 1/8 through 12/8, common time and cut time. The time signature can be changed by the Velcro number and letter pieces. The black sliding apparatus (measure delineator) can be adjusted to show the physical length of the measure.

There are fourteen (14) counting strips. Exemplars include, Quarters (1, 2, 3, 4, 5, 6), 8^{th}'s (1 &, 2 &, 3 &, 4 &, 5 &, 6 & (for quarter note time signatures)), 8^{th}'s (1, 2, 3, 4, 5, 6, 7, 8, 9, 10, 11, 12 (for 8^{th} note time signatures)), 16^{th}'s (1e&a, 2e&a, 3e&a, 4e&a, 5e&a, 6e&a (for “Common Time”) and Cut time (1 e&a, 2e&a, 3e&a (for “Cut Time” or “Alla Breva” signature)). as it serves as the place where the parts of the rhythm to be counted and played are installed—or built. The bars are of varying type, namely, beat bars 30 and counting bars 32 which are installed in the beat bar housing 22 and the counting bar housing 24 of the build board 14, respectively.

Movably affixed to the display portion 14 of the visual rhythm instructional apparatus 10 is a measure delineator 26 that moves perpendicularly with respect to the longitude of the notes 18 and bars 30 and 32.

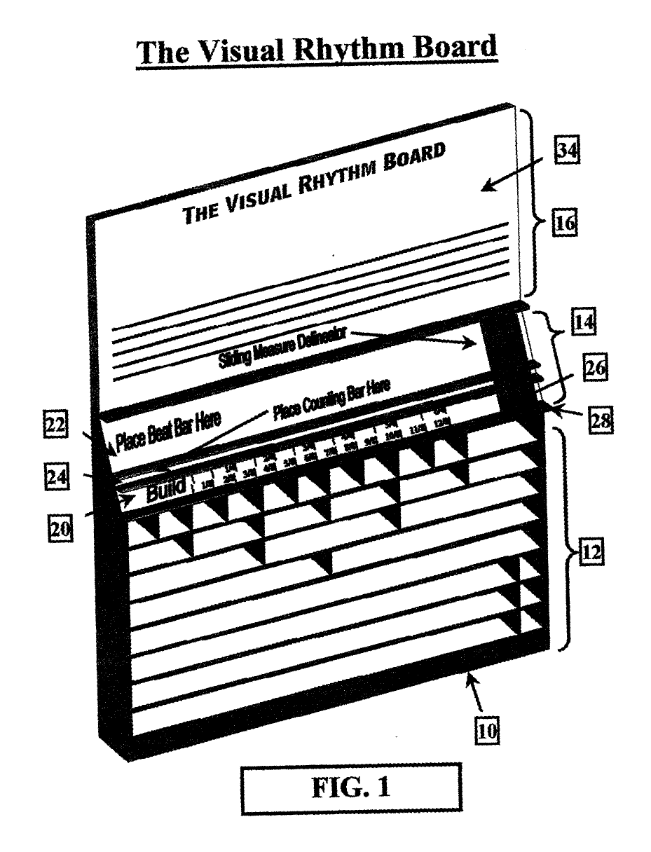

In the exemplary embodiment illustrated in FIG. 1, the workstation 16 is located above the display portion 14 and comprises a reusable display board 34 such as a white board that uses erasable markers. One of ordinary skill in the relevant art would appreciate that various other forms of reusable or replaceable writing surfaces could be configured for use with the visual rhythm instructional apparatus 10 in accordance with the present invention. It must also be kept in mind that though it is desirable that the storage portion 12, the display portion 14 and the workstation portion 16 be configured as discussed above, it should in no way be construed as limiting the visual rhythm instructional apparatus 10 to such configuration. In fact, the various portions could be side by side or designed in an inverted configuration, in contrast to the above discussion. In short, it would be obvious, in light of the present specification, to manipulate the spatial arrangement of the portions of the visual rhythm instructional apparatus 10, in accordance with the present invention.

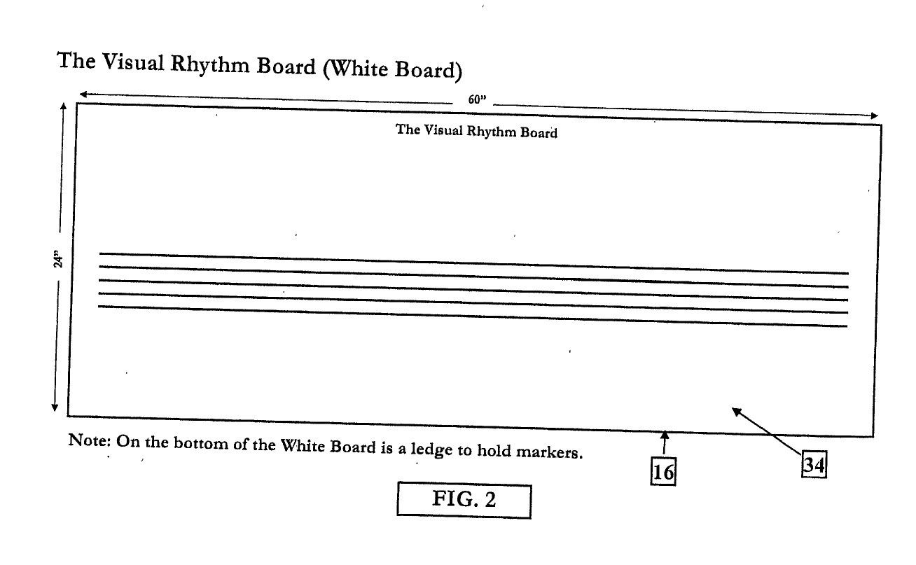

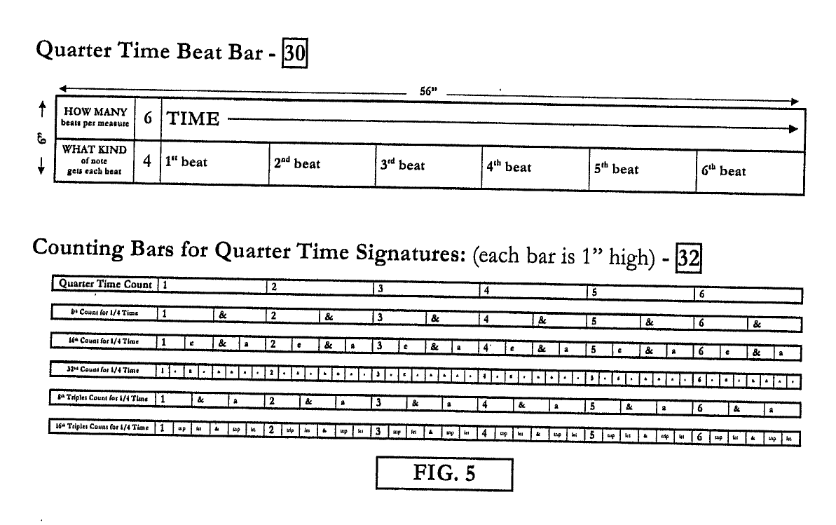

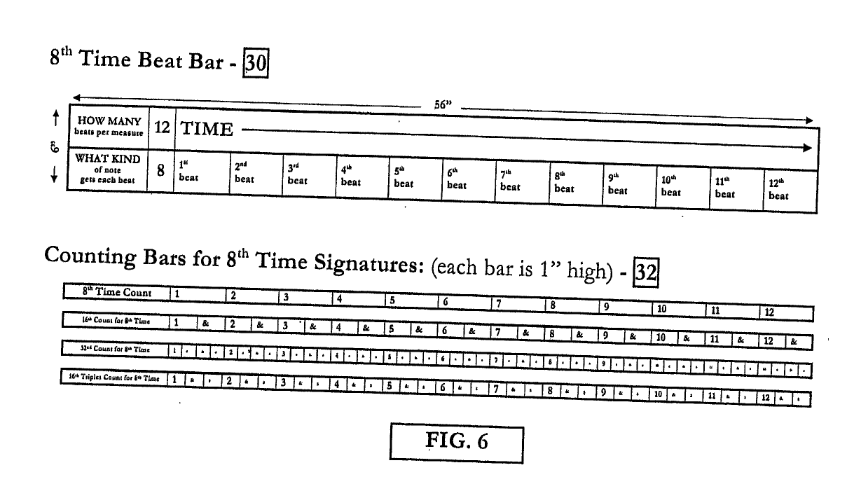

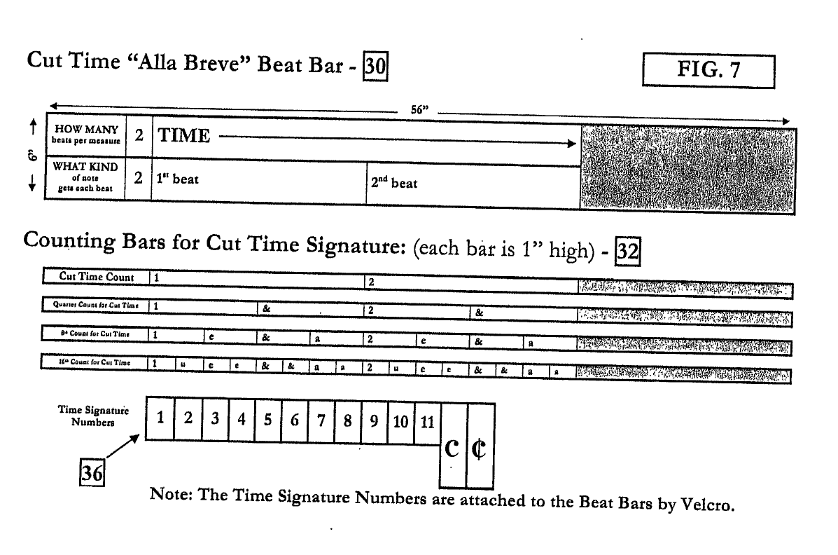

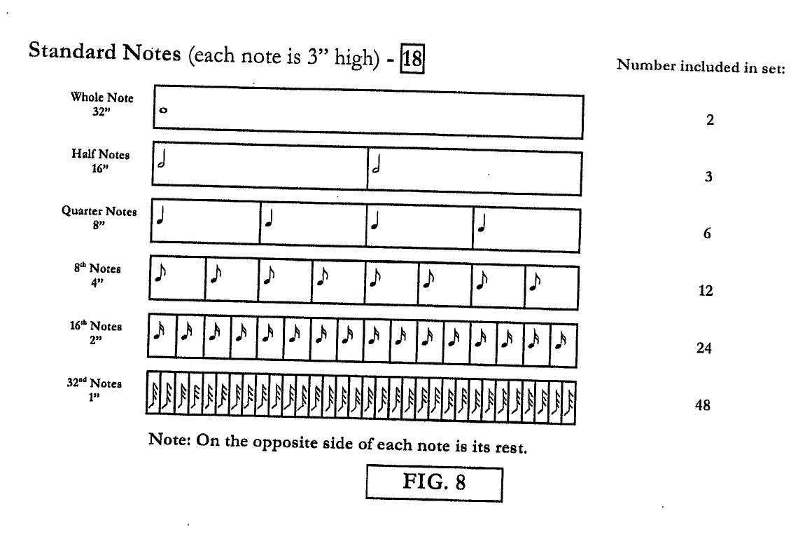

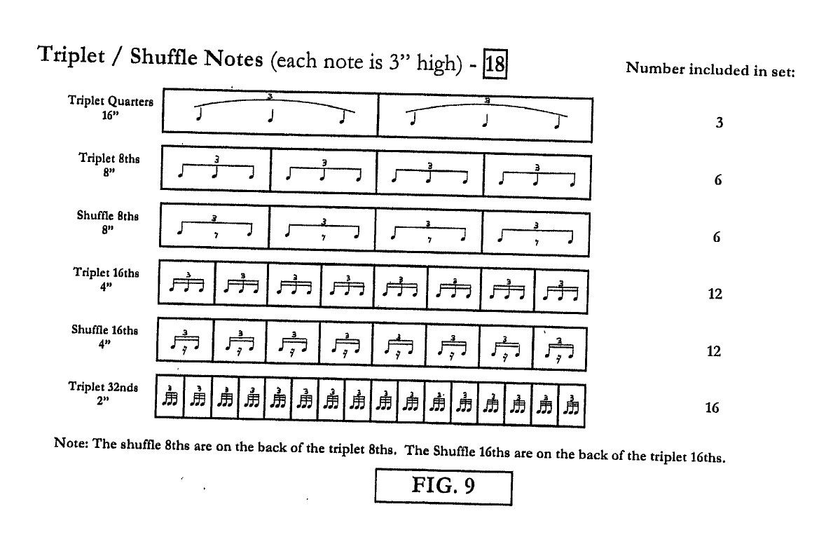

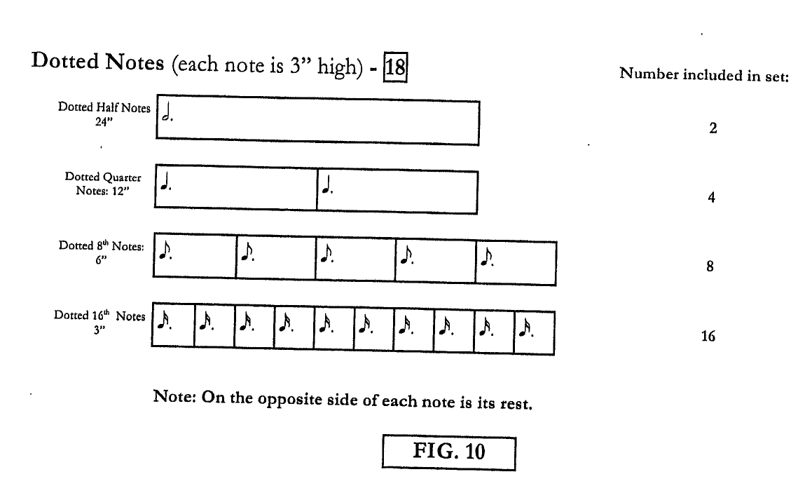

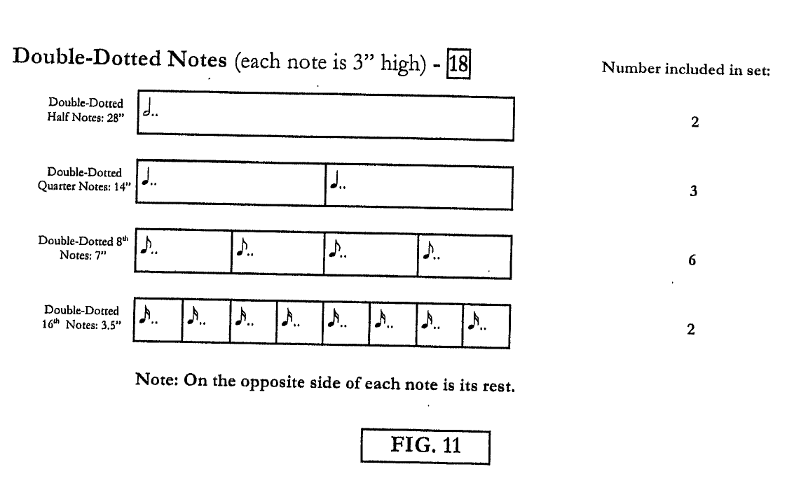

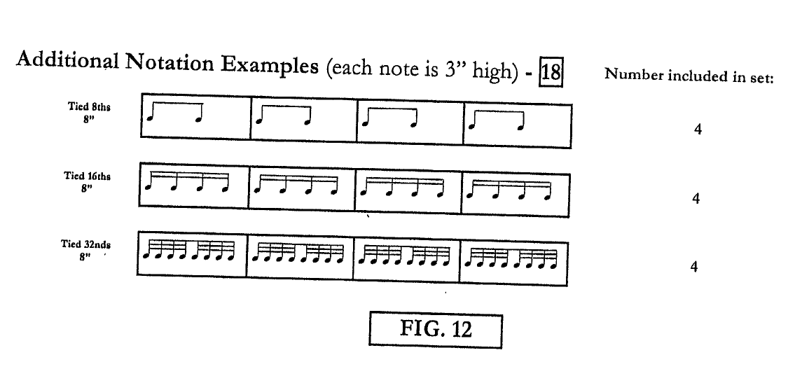

Turning now to FIG. 2, the workstation 16 is illustrated at a preferred 60-inch length and 24-inch height. FIGS. 5-12 also show the relative dimensions of the various notes 18 and beats 30 and 32. As with all of the notes 18 and bars 30 and 32, the dimensions are preferred and the principal importance is the relative length with respect to one another. Since the invention represents “time” which is a measurable entity, the relative length of each note and bar and their relationship to one another must be kept mathematically.

Musical notation is a “math” language for playing music. It mathematically divides time into pieces. A whole note represents a whole measure or the equivalent of four quarters and one eighth is the equivalent of two sixteenths, etc. All musical notes have a distinct relationship to each other. The visual rhythm apparatus is like a building block set, enabling a teacher or student to construct (build) a measure of rhythm. Musical notation is also a “math” of fractions. Four eighths equal two quarters etc. The visual rhythm apparatus takes fractions and puts them in the visual and physical realm making the language of musical rhythm much easier to understand.

The visual rhythm apparatus is a teaching aid for both private and classroom rhythm education. The apparatus can be used for any instrument, which uses traditional musical notation. There are four types of learning processes. They are mental, physical, visual, and auditory. Three of the most effective learning processes are visual, physical and auditory. Because the visual rhythm apparatus brings the concept of “time” into the visual, the retention of a student multiplies several times. Because the visual rhythm apparatus also brings the concept of “time” into the physical, the retention of the student multiplies once again. Once the rhythm is counted and played, the auditory process of learning is brought into place. Again, when any

On the “visual rhythm apparatus,” the bottom row is for building your measure. An exemplary method for building the measure is as follows: putting the proper beat bar in place; establishing the time signature by putting the proper upper and lower numbers in place, with a reversible adhesion means, preferably Velcro®; putting the proper counting bar in place and sliding the measure delineator on the visual rhythm apparatus in the proper place to establish the physical end of the measure; building the rhythm with the notes/rests by placing them one by one on the ledge in the “build” section; and counting and playing the rhythm!

Referring now to the figures, where like numbers refer to like parts, the visual rhythm instructional apparatus is referred to generally as 10, where the visual display apparatus 10 comprises a shelving like system. In a preferred embodiment, the shelving system has three principal portions, the storage portion 12, the display portion 14, and the workstation portion 16. In an exemplary embodiment, in accordance with the present invention, the storage portion 12 is located at the bottom of the visual rhythm instructional apparatus 10 (As also shown in FIG. 4). Above the storage portion 12 is the display portion 14, which is functionally important as the place where the various pieces (notes 18 and bars 30 and 32) are installed to facilitate counting and playing rhythm.

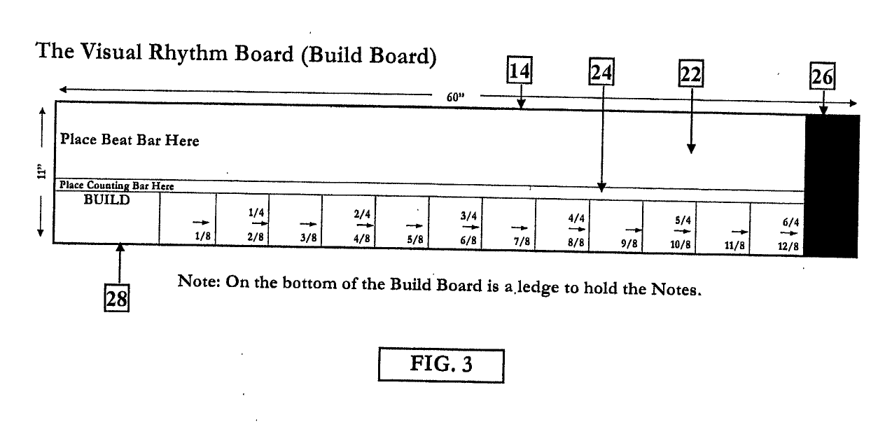

In particular, the display portion 14, also shown in FIG. 3, is divided into further sections, namely, the beat bar housing 22, the counting bar housing 24, the sliding measure delineator 26 and a ledge 28 for holding the notes 18 in place in the build housing 20. The display portion 14 may alternatively be referred to as the build board aid to education uses all four mental, visual, physical, and auditory learning processes, understanding and comprehension is multiplied manifold.

Basic music notation is universal worldwide. A whole note is a whole note, a half note is a half note, etc. Therefore, international versions of the visual rhythm apparatus can be produced in all languages. The only translation necessary is for the instructions, and for the words and numbers on the apparatus. Also, international versions for the blind will be produced with raised notes/rests, time signatures, and counting bars, to assist the blind worldwide in learning and reading and writing rhythm notation.

In any language a student needs to learn to understand, speak, and write the language in order to communicate effectively. The visual rhythm apparatus' objective is to help a student understand rhythm through the four learning processes, namely, mental, physical, visual, and auditory, and to express themselves musically in written form. Once a student understands rhythm within these four processes they are then able to identify a rhythm mentally and audibly, and then translate it into written form with the proper count. Hence, they are able to write the language of rhythm notation and communicate musically to the fullest extent.

In operation, the visual rhythm apparatus assists in rhythm education as follows. Many times a student will play the rhythm in a measure incorrectly. When this occurs, the teacher will have the student determine the time signature for the measure and then place the correct time signature numbers and beat board in place on the apparatus. Then they will place the proper counting bar in place showing them the correct way to count the rhythm. The next step is to slide the measure delineator to the proper time signature as shown on the board. Now the exact length of the measure has been determined. Then they determine each note and rest within the measure and physically place one by one in the build section. This is much like placing blocks of different lengths in a straight row one after the other. Once all the notes and rests have been placed, the rhythm can then be read, counted, and played correctly. Now that the student understands the rhythm and the count, they can return to their instrument and play the rhythm within the measure correctly.

The visual rhythm apparatus also solves another potential problem. Many students play instruments “by ear.” This means that they are able to hear a rhythm or piece of music and play it on their instrument without the aid of written music notation. In the private or classroom experience many times a student plays a piece of music “by ear” (because they have heard it previously) and it is assumed the student understands the written notation. However, this is far from the truth. If the student was requested to play the piece without having heard it previously they would not be able to do so. Many times when a teacher brings a new piece of music to a student, the student requests the teacher to first play the piece so the student will know how it is to be played. A good teacher will be aware of this potential problem and require the student to play it without having heard it first. This requires that the student have an understanding of note values and their proper counts. If the student is unable to play the music, it is evident that the student needs assistance in understanding note values and counting. As guided by the teacher, using the Visual Rhythm apparatus, the student can then build each measure, one by one. This will insure that the student understands note values, the proper count, and that they are not playing “by ear.”

As an aid to the blind, the visual rhythm apparatus with raised notes/rests, counting bars, and time signatures is a suitable teaching tool. Each piece is readily recognizable through touch. Each note/rest is also immediately recognizable by its length. Each measure will be built by placing the notes/rests in place and then the rhythm can be played. For the blind, musical notation and rhythm becomes visual through touch. The visual rhythm apparatus becomes virtual “sight” for the blind. When a description of a note/rest or measure is discussed, the blind will understand the notes time value fully because they have touched it and “seen” it in the physical realm. Through the visual rhythm apparatus understanding musical notation and rhythm for the blind is brought to an entirely new level. Building rhythm on the visual rhythm apparatus is like building blocks, placing blocks of different lengths together one after the other and establishing a rhythm. This process will assist the blind in understanding musical rhythm notation. International versions for the blind with raised notes/rests, counting bars, and time signatures, can be easily produced for teachers in all languages.

The benefits of the various versions of the visual rhythm apparatus can also be enjoyed in a computer readable format.

The software version of the visual rhythm instructional apparatus and method gives the user a visual experience analogous to that of the hardware versions, with the convenience of building and storing multiple rhythms. Much like the hardware version, the user can build a rhythm note by note in a predetermined measure and have the opportunity to visualize the building thereof. In a preferred embodiment in accordance with the present invention, each note and beat may correspond to a key on the computer keyboard, to facilitate the building process. Alternatively, the various notes and beats may be displayed on a portion of the screen and may be introduced to the measure by a point-and-click method. It should be kept in mind that a variety of visual interface configurations may be employed to carryout the principal objective of allowing a user to learn how to read notes and rhythm through visual interaction with the visual rhythm instructional apparatus. In the computer readable format, the method for teaching a user to read notes and rhythm is preferably implemented in the C++ programming language and is operational on a conventional computer system. This invention may be implemented in a client-server environment, but a client-server environment (a conventional client-server computer system that includes a server and numerous clients) is not essential. The use of the term “server” is used in the context of the invention, wherein the server receives queries from (typically remote) clients, does substantially all the processing necessary to formulate responses to the queries, and provides these responses to the clients. To this end, multiple clients can access the instructional tool to build rhythms. However, the server may itself act in the capacity of a client when it accesses remote databases located at another node acting as a database server.

The hardware configurations are in general standard and will be described only briefly. In accordance with known practice, servers include one or more processors that communicate with a number of peripheral devices via a bus subsystem. These peripheral devices typically include a storage subsystem, comprised of memory subsystem and file storage subsystem. The storage subsystem is disposed to hold computer programs (e.g., code or instructions) and data. Other peripheral devices include a set of user interface input and output devices, and an interface to outside networks, which may employ Ethernet, Token Ring, ATM, IEEE 802.3, ITU X.25, Ser. Link Internet Protocol (SLIP) or the public switched telephone network. This interface is shown schematically as a “Network Interface” block. It is coupled to corresponding interface devices in client computers via a network connection.

Clients have the same general configuration, although typically with less storage and processing capability. Thus, while the client computer could be a terminal or a low-end personal computer, the server computer is generally a high-end workstation or mainframe, such as a SUN SPARC.TM. server. Corresponding elements and subsystems in the client computer are shown with corresponding, but primed, reference numerals. The user interface input devices typically includes a keyboard and may further include a pointing device and a scanner. The pointing device may be an indirect pointing device such as a mouse, trackball, touch pad, or graphics tablet, or a direct pointing device such as a touch screen incorporated into the display. Other types of user interface input devices, such as voice recognition systems, are also possible.

The user interface output devices typically include a printer and a display subsystem, which includes a display controller and a display device coupled to the controller. The display device may be a cathode ray tube (CRT), a flat-panel device such as a liquid crystal display (LCD), or a projection device. The display controller provides control signals to the display device and normally includes a display memory for storing the pixels that appear on the display device. The display subsystem may also provide non-visual display such as audio output.

The memory subsystem typically includes a number of memories including a main random access memory (RAM) for storage of instructions and data during program execution and a read only memory (ROM) in which fixed instructions are stored. In the case of Macintosh-compatible personal computers the ROM would include portions of the operating system; in the case of IBM-compatible personal computers, this would include the BIOS (basic input/output system).

The file storage subsystem provides persistent (non-volatile) storage for program and data files, and typically includes at least one hard disk drive and at least one floppy disk drive (with associated removable media). There may also be other devices such as a CD-ROM drive and optical drives (all with their associated removable media). Additionally, the computer system may include drives of the type with removable media cartridges. The removable media cartridges may, for example be hard disk cartridges, such as those marketed by SyQuest and others, and flexible disk cartridges, such as those marketed by Iomega. One or more of the drives may be located at a remote location, such as in a server on a local area network or at a site of the Internet's World Wide Web.

In this context, the term “bus subsystem” is used generically so as to include any mechanism for letting the various components and subsystems communicate with each other as intended. With the exception of the input devices and the display, the other components need not be at the same physical location. Thus, for example, portions of the file storage system could be connected via various local-area or wide-area network media, including telephone lines. Similarly, the input devices and display need not be at the same location as the processor, although it is anticipated that the present invention will most often be implemented in the context of PCs and workstations.

A bus subsystem can be a single bus, but a typical system has a number of buses such as a local bus and one or more expansion buses (e.g., ADB, SCSI, ISA, EISA, MCA, NuBus, or PCI), as well as serial and parallel ports. Network connections are usually established through a device such as a network adapter on one of these expansion buses or a modem on a serial port. The client computer may be a desktop system or a portable system. In particular, the software package is adaptable in both desktop form and can be suitably configured for mobile computing devices such as laptops and personal digital assistants (PDAs).

A TCP/IP “stack” works in conjunction with the operating system to communicate with processes over a network or serial connection attaching the server to the Internet. Web server software executes concurrently and cooperatively with other processes in the server to make data objects available to requesting clients. A Common Gateway Interface (CGI) script enables information from user clients to be acted upon by a web server, or other processes within the server. Responses to client queries may be returned to the clients in the form of a Hypertext Markup Language (HTML) document outputs, which are then communicated via the Internet back to the user.

A Client may possess software implementing functional processes operatively disposed in its program and data storage. The TCP/IP stack works in conjunction with the Operating System to communicate with processes over a network or serial connection attaching a Client to the Internet. Software implementing the function of a web browser executes concurrently and cooperatively with other processes in the client to make requests of the server for data objects. The user of the client may interact via the web browser to make such queries of the server via the Internet and to view responses from the server via the Internet on the web browser. It must be kept in mind, however, that though the invention has been described in a networked environment, the present invention can also be configured in a stand-alone single computer environment.

In practice, it is preferable that the software version of the invention is configured to play back the rhythm audibly through standard music Instrument Digital Interface (MIDI) technology. One of ordinary skill in the relevant art would understand how to program the software for MIDI plug-in compatibility.

Pronounced middy, MIDI is a standard adopted by the electronic music industry for controlling devices, such as synthesizers and sound cards that emit music. At minimum, a MIDI representation of a sound includes values for the note's pitch, length, and volume. It can also include additional characteristics, such as attack and delay time. Most synthesizers support the MIDI standard, so sounds created on one synthesizer can be played and manipulated on another synthesizer. Computers that have a MIDI interface can record sounds created by a synthesizer and then manipulate the data to produce new sounds. For example, you can change the key of a composition with a single keystroke.

A number of software programs are available for composing and editing music that conforms to the MIDI standard. They offer a variety of functions: for instance, when you play a tune on a keyboard connected to a computer, a music program can translate what you play into a written score. This would enable the student to hear back the rhythm they build automatically. It is also understood that the software suite is adjustable speed-wise by the use of metronome tempos. Moreover, the student would also be able to hear the count played back as well. This could preferably be performed by employing a voice wave file of each counting bar that automatically adjusts to the correct metronome tempo. Both audio options would be available as stand alone options or can be configured in tandem within the shipped product itself.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes, which come within the meaning and range of equivalency of the claims, are to be embraced within their scope.

What is claimed is:

1. A visual instructional apparatus for teaching students how to read notes and rhythm, the visual instruction apparatus comprising:
a frame, the frame having a top, a bottom, a left side and a right side, and a front and a back, the front having at least a display portion; and
a multiplicity of attachable members having indicia thereon, the attachable members configured with means for attaching the attachable members to the display portion of the frame.

2. The visual instructional apparatus of claim 1, further comprising a storage portion.

3. The visual instructional apparatus of claim 1, wherein the means for attaching provides reversible attachability between the attachable members and the display portion.

4. The visual instructional apparatus of claim 1, wherein the indicia on the attachable members are selected from the group consisting of counting bars, notes/rests, and time signature numbers.

5. The visual instructional apparatus of claim 4, wherein the indicia on the attachable members are in the English language.

6. The visual instructional apparatus of claim 5, wherein the indicia are in a language other than English.

7. The visual instructional apparatus of claim 4, wherein the language is selected from the group consisting of Afrikaans, Aleut, Aninishinaabe (Chippewa/Ojibwe), Arabic, Armenian, Azerbaijani, Basque, Bengali, Bosnian, Braille, Bulgarian, Chamorro, Cherokee, Cheyenne, Chinese, Chinook, Choctaw, Cornish, Cree, Croatian, Czech, Dakota, Dutch, Esperanto, Estonian, Farsi/Persion, Finnish, French, Georgian, German, Greek, Gujarati, Hawaiian, Hebrew, Hindi, Hmong, Hungarian, Hupa, Icelandic, Indonesian, Inuktitut, lnupiaq, Irish (Gaelic) Italian, Japanese, Kikuyu, Kiribati, Korean, Kurdish, Latin, Latvian, Lithuanian, Luganda, Malaysian, Maltese, Maori, Mayan, Miwok, Mohawk, Mon, Mongolian, Nahuatl (Aztec), Navajo, Ndbele, Norwegian, Paiute, Polish, Portuguese, Potawatomi, Quechua, Romanian Russian, Saami (Lapp), Samoan, Scottish Gaelic, Seneca (Mingo), Serbian, Sesotho, Shona, Sign Language, Sinhalese, Spanish, Swahili, Swedish, Tagalog, Tahitian, Tai, Tamil, Tibetan, Tlingit, Turkish, Urdu, Ukrainian, Vietnamese, Welsh, Xhosa, Yiddish, Yupik and Zulu.

8. The visual instructional apparatus of claim 7, wherein the indicia are in braille.

9. The visual instructional apparatus of claim 1, further comprising a measure delineator movably coupled with the frame and usable on the display portion, for specifying the physical length of the measure.

10. A method of using a visual instructional apparatus to teach a student how to read notes and rhythm by using an apparatus having a display section, the method comprising the steps of:
putting a beat bar in place;
establishing a time signature by reversibly installing the proper upper and lower numbers in place;
putting a counting bar in place;
sliding a measure delineator on the visual instructional apparatus to establish the physical end of the measure; and
building a rhythm with notes/rests by placing the notes/rests into the display section.

11. The method of claim 10, the method further comprising the step of counting the rhythm.

12. The method of claim 11, the method further comprising the step of playing the rhythm.

13. The method of claim 10, the method further comprising the step of playing the rhythm.

14. A computer-implemented process wherein a sequential combination of visual music components informs a user to read notes and rhythm.

15. The computer-implemented process of claim 14, wherein the visual music components are selected from the group consisting of counting bars, notes/rests, and time signature numbers.

16. The visual instructional apparatus of claim 15, wherein the visual music components are displayed on a screen in the English language.

17. The visual instructional apparatus of claim 15, wherein the visual music components are in a language other than English.

18. The visual instructional apparatus of claim 17, wherein the language is selected from the group consisting of Afrikaans, Aleut, Aninishinaabe (Chippewa/Ojibwe), Arabic, Armenian, Azerbaijani, Basque, Bengali, Bosnian, Braille, Bulgarian, Chamorro, Cherokee, Cheyenne, Chinese, Chinook, Choctaw, Cornish, Cree, Croatian, Czech, Dakota, Dutch, Esperanto, Estonian, Farsi/Persion, Finnish, French, Georgian, German, Greek, Gujarati, Hawaiian, Hebrew, Hindi, Hmong, Hungarian, Hupa, Icelandic, Indonesian, Inuktitut, lnupiaq, Irish (Gaelic) Italian, Japanese, Kikuyu, Kiribati, Korean, Kurdish, Latin, Latvian, Lithuanian, Luganda, Malaysian, Maltese, Maori, Mayan, Miwok, Mohawk, Mon, Mongolian, Nahuatl (Aztec), Navajo, Ndbele, Norwegian, Paiute, Polish, Portuguese, Potawatomi, Quechua, Romanian Russian, Saami (Lapp), Samoan, Scottish Gaelic, Seneca (Mingo), Serbian, Sesotho, Shona, Sign Language, Sinhalese, Spanish, Swahili, Swedish, Tagalog, Tahitian, Tai, Tamil, Tibetan, Tlingit, Turkish, Urdu, Ukrainian, Vietnamese, Welsh, Xhosa, Yiddish, Yupik and Zulu.

19. An article of manufacture comprising a computer-readable medium having stored thereon instructions adapted to be executed by a processor, the instructions which, when executed, define a series of steps to facilitate a user's ability to learn how to read notes and rhythm, said steps comprising:
receiving from the user a command message, the command message being received by the processor to establish a time signature and measure length;
building a rhythm with notes/rests by placing the notes/rests one by one into the measure; and
displaying the resulting rhythm visually on a visual display.

20. The article of manufacture of claim 1, further comprising the step of playing back the notes and rhythm.
